(19) United States
(12) Patent Application Publication
(10) Pub. No.: US 2026/0236998 A1
(43) Pub. Date: Aug. 13, 2026

(54) SYSTEM AND METHODS FOR OBTAINING REGULATED CROWD-SOURCED FUNDS

(71) Applicant: Founders Studio, LLC, Wayne, PA (US)

(72) Inventor: Michael Carter, Wayne, PA (US)

(21) Appl. No.: 19/537,861

(22) Filed: Feb. 12, 2026

Related U.S. Application Data
(60) Provisional application No. 63/757,405, filed on Feb. 12, 2025.

(51) Int. Cl. G06Q 40/06

(52) U.S. Cl. CPC G06Q 40/068

(57) ABSTRACT

The techniques described herein relate to a system and method for obtaining regulated crowd-sourced funds, the system including: at least one processor, and a memory communicatively connected to the at least one processor, wherein the memory contains instructions configuring the at least one processor to: receive, from a user, an input including roadmap task data related to a roadmap; input the roadmap task data into a chatbot; and determine, using the chatbot, an output, wherein the output includes one or more suggested actions, wherein the suggested actions are configured to move a user along the roadmap.

### CROSS REFERENCE TO RELATED APPLICATIONS

This application claims the benefit of priority to U.S. Provisional Application 63/757,405, filed on Feb. 12, 2025, and entitled “SYSTEM AND METHODS FOR OBTAINING REGULATED CROWD-SOURCED FUNDS,” the entirety of which is incorporated herein by reference.

### FIELD OF THE INVENTION

The present invention relates to a method and system for AI assisted system and methods for obtaining regulated crowd-sourced funds.

### BRIEF SUMMARY OF THE INVENTION

In an exemplary embodiment, systems and methods may be provided for AI assisted system and methods for obtaining regulated crowd-sourced funds.

In some aspects, the techniques described herein relate to a system for obtaining regulated crowd-sourced funds, the system including: at least one processor, and a memory communicatively connected to the at least one processor, wherein the memory contains instructions configuring the at least one processor to: receive, from a user, an input including roadmap task data related to a roadmap; input the roadmap task data into a chatbot; and determine, using the chatbot, an output, wherein the output includes one or more suggested actions, wherein the suggested actions are configured to move a user along the roadmap.

In some aspects, the techniques described herein relate to a method for obtaining regulated crowd-sourced funds, the method including: receiving, using at least one processor, from a user, an input including roadmap task data related to a roadmap; inputting, using the at least one processor, the roadmap task data into a chatbot; and determining, using the at least one processor and the chatbot, an output, wherein the output includes one or more suggested actions, wherein the suggested actions are configured to move a user along the roadmap.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BACKGROUND

Crowdfunding is a method of raising capital for projects, ventures, or causes by soliciting contributions from a large number of people, typically through online platforms. The fundamental idea behind crowdfunding is to harness the collective financial power of many individuals, each contributing small amounts, to reach a larger funding goal. This approach has become increasingly popular in recent years, thanks to the rise of social media and digital platforms that make it easier for people to connect, share ideas, and contribute to initiatives they care about.

Crowdfunding can be broken down into several key models: reward-based, equity-based, donation-based, and debt-based crowdfunding. Each model caters to different types of projects and goals

1. Reward-based crowdfunding: In this model, individuals contribute money to a project in exchange for a reward, which is often a product or service related to the project. This is the most common type of crowdfunding, particularly for creative endeavors, such as launching a new product, film, or art project. Popular platforms like Kickstarter and Indiegogo primarily operate under this model. Backers typically receive tangible rewards for their contributions, such as early access to a product or exclusive merchandise.

2. Equity-based crowdfunding: Unlike reward-based crowdfunding, equity-based crowdfunding involves individuals investing money in exchange for shares or equity in the business or project. This model is primarily used by startups or growing businesses looking to raise capital to expand. Investors in equity crowdfunding hope to benefit from the future financial success of the business. Platforms like Crowdcube and Seedrs specialize in this type of crowdfunding.

3. Donation-based crowdfunding: This model involves individuals contributing to a cause or charity without expecting anything in return. It is commonly used for personal or social causes, such as medical expenses, disaster relief, or nonprofit initiatives. Websites like GoFundMe and JustGiving are popular platforms for donation-based crowdfunding. Donors typically contribute out of goodwill and a desire to help others.

4. Debt-based crowdfunding (also known as peer-to-peer lending): In debt-based crowdfunding, individuals lend money to businesses or individuals with the expectation that it will be repaid with interest. This model provides an alternative to traditional loans from banks and financial institutions. Platforms like Funding Circle and LendingClub operate under this model, allowing individuals to become lenders and earn interest on their investments.

The rise of crowdfunding has been enabled by online platforms that connect project creators with a global audience. These platforms provide tools for creators to present their ideas, set fundraising goals, and offer rewards or incentives to contributors. Social media also plays a significant role in promoting crowdfunding campaigns, as creators can easily share their projects with their networks, gaining exposure and attracting potential backers.

One of the key advantages of crowdfunding is its ability to democratize access to capital. Traditionally, businesses or individuals seeking funding would rely on investors, banks, or venture capitalists, who typically hold significant power in deciding whether a project would receive funding. Crowdfunding, on the other hand, allows anyone with a good idea to access funding from a broad range of supporters. It also provides a platform for market validation, as backers' willingness to contribute can be a sign of interest and demand for the project or product.

However, crowdfunding also has its challenges. Successful campaigns require strong marketing and communication strategies to stand out in a crowded marketplace. There is also the risk that a campaign may fail to meet its fundraising goal, which could leave creators without the funds they need to complete the project. Additionally, creators may face legal and logistical challenges, especially in reward-based or equity crowdfunding, where backers may have specific expectations or rights.

Crowdfunding has revolutionized the way individuals and businesses raise funds, offering new opportunities for entrepreneurs, creatives, and causes to gather financial support from a large and diverse group of people. It has transformed the traditional funding model by emphasizing the power of community and the potential of small, collective contributions. Despite its challenges, crowdfunding continues to thrive as a viable and exciting avenue for innovation and social change.

Regulation Crowdfunding (RegCF) is a framework established by the U.S. Securities and Exchange Commission (SEC) that allows eligible companies—typically startups and small businesses—to raise capital by offering securities to a broad base of investors through online crowdfunding platforms. Introduced under the Jumpstart Our Business Startups (JOBS) Act of 2012 and refined in subsequent years, RegCF democratizes the fundraising process by enabling both accredited and non-accredited investors to participate, thereby expanding the pool of available capital beyond traditional sources such as venture capital or bank loans.

Under RegCF, companies can raise up to $5 million within a 12-month period. This limit is designed to balance the need for businesses to access capital with the protection of investors, ensuring that individual investors are not exposed to undue financial risk. To participate in a RegCF offering, companies must use an SEC-registered intermediary, typically a crowdfunding portal or broker-dealer, which plays a critical role in facilitating the process and ensuring compliance with regulatory requirements.

One of the cornerstones of RegCF is the emphasis on transparency. Companies are required to file detailed disclosures with the SEC before launching their crowdfunding campaigns. These disclosures include comprehensive information about the company’s business model, financial condition, management team, and the specific terms of the offering. Additionally, companies must provide periodic updates to investors, ensuring that those who contribute capital are kept informed about the company’s progress and any significant developments. This ongoing disclosure regime is essential for building trust and helping investors make informed decisions in a market that, by nature, involves higher risks.

Investor protection is another critical aspect of RegCF. Recognizing that many participants may be new to investing, the regulation imposes investment limits on non-accredited investors based on their annual income or net worth. These limits are designed to prevent individuals from investing more than they can afford to lose. Accredited investors, by contrast, typically face fewer restrictions due to their higher level of financial sophistication and access to resources. This tiered approach helps to safeguard less experienced investors while still allowing them the opportunity to participate in potentially high-growth ventures.

RegCF has played a transformative role in the capital-raising landscape by providing startups and emerging businesses with access to a wider array of funding sources. This inclusivity has not only spurred innovation by giving more companies the resources needed to grow but has also allowed everyday investors to partake in early-stage ventures that were once the exclusive domain of wealthy individuals and institutional investors. However, it is important for potential investors to approach these opportunities with caution. Investments in early-stage companies inherently carry risks, including the possibility of complete loss of capital, and thus require thorough due diligence and a clear understanding of the business proposition.

In summary, Regulation Crowdfunding represents a significant evolution in securities regulation. By opening the doors of investment to a broader segment of the public, it fosters innovation, diversifies capital sources, and brings greater transparency and investor protection to the crowdfunding space. While offering exciting opportunities for both companies and investors, RegCF also underscores the importance of careful risk management and informed decision-making in the dynamic world of early-stage investing.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 shows an exemplary embodiment of a method for obtaining regulated crowd-sourced funds;

FIG. 2 shows an exemplary embodiment of a system for obtaining regulated crowd-sourced funds;

FIG. 3. shows an exemplary data related to a system for obtaining regulated crowd-sourced funds;

FIG. 4 shows an exemplary user interface;

FIG. 5 shows an exemplary machine-learning module; and

FIG. 6 shows an exemplary embodiment of a computing device in the exemplary form of a computer system.

### DETAILED DESCRIPTION

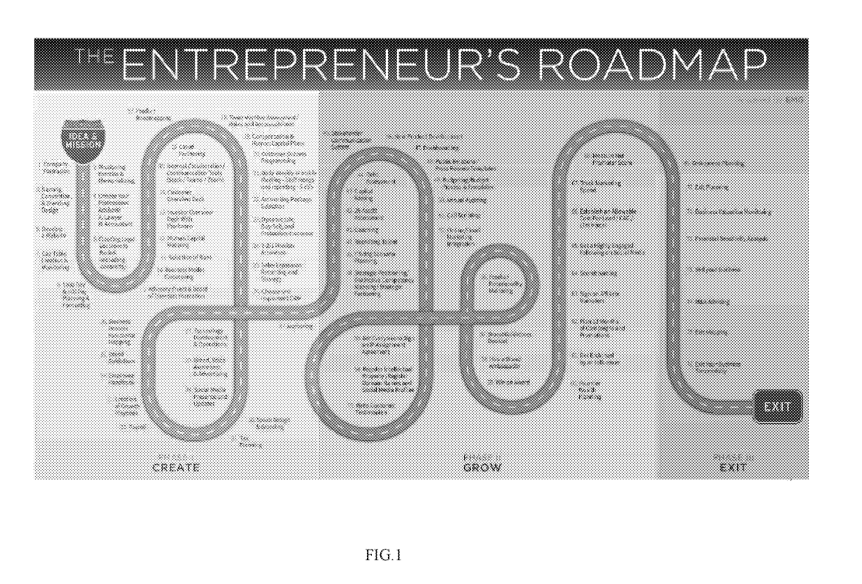

Referring now to FIG. 1, an exemplary embodiment of a method for obtaining regulated crowd-sourced funds is shown. In some embodiments, method for obtaining regulated crowd-sourced funds may be implemented using a system for obtaining regulated crowd-sourced funds as described throughout this disclosure. System may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, processor may be designed and/or configured to perform any method, method step, or sequence of method steps in any embodiment described in this disclosure, in any order and with any degree of repetition. For instance, processor may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. processor may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, in some embodiments, method may include an online, AI-enabled service for entrepreneurs that defines the 77 steps needed to complete and then connections the entrepreneur to the service provider or resource to help them complete the step. The invention may include the online/digital design of the Entrepreneurs Roadmap and the engagement by the AI Chatbot for the purpose of helping the entrepreneur complete their roadmap tasks.

In some aspects, the techniques described herein relate to a system for obtaining regulated crowd-sourced funds, the system including: at least one processor, and a memory communicatively connected to the at least one processor, wherein the memory contains instructions configuring the at least one processor to: receive, from a user, an input including roadmap task data related to a roadmap; input the roadmap task data into a chatbot; and determine, using the chatbot, an output, wherein the output includes one or more suggested actions, wherein the suggested actions are configured to move a user along the roadmap.

Chatbot may be configured to process the input using natural language processing. This may include tokenization. In some embodiments, chatbot may parse tokens of input. In some embodiments, chatbot may be configured to normalize the text (this may include, as a non-limiting example, removing punctuation, formatting, or the like)./ In some embodiments, chatbot may use a decision tree to determine an output. In some embodiments, chatbot may employ a rule based system to generate an output. In some embodiments, decision tree may include a decision tree configured to determine, based on an input, whether a user has accomplished a step in FIG. 1 and suggest the next step.

In some aspects, the techniques described herein relate to a system, wherein the user is an entrepreneur.

In some aspects, the techniques described herein relate to a system, wherein the roadmap includes an entrepreneur's roadmap. An embodiment of entrepreneur’s roadmap is described in FIG. 1.

In some aspects, the techniques described herein relate to a system, wherein: the entrepreneur's roadmap includes a plurality of roadmap tasks; and each of the plurality of roadmap tasks is assigned to a category chosen from the list consisting of create, grow, and exit.

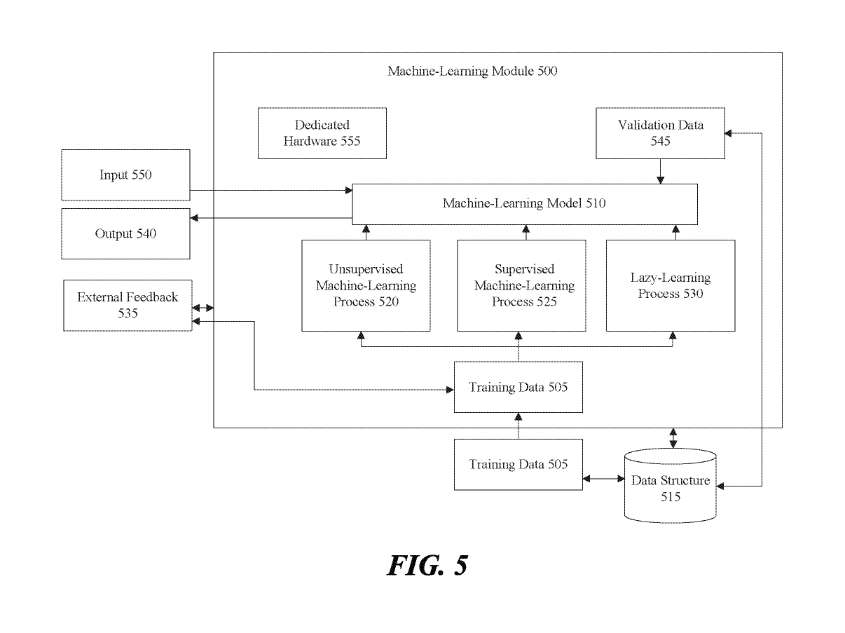

In some aspects, the techniques described herein relate to a system, wherein, the chatbot includes an artificial-intelligence enabled chatbot. Artificial intelligence may include a machine-learning model trained using a machine-learning module as described further with respect to FIG. 5. In some embodiments, artificial intelligence may include a natural language classifier.

In some aspects, the techniques described herein relate to a system, wherein the artificial-intelligence enabled chatbot includes a large language model (LLM), wherein the large language model (LLM) is configured to generate textual data as output in response to the input received from the user. a “large language model,” or “LLM,” as used herein, is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, novels, blog posts, articles, emails, unstructured data, electronic records, and the like. In some embodiments, training sets may include a variety of subject matters, such as, as nonlimiting examples, academic report documents, entity documents, business documents, inventory documentation, emails, user communications, advertising documents, newspaper articles, and the like. In some embodiments, training sets of an LLM may include information from one or more public or private databases. As a non-limiting example, training sets may include databases associated with an entity. In some embodiments, training sets may include portions of documents associated with the electronic records correlated to examples of outputs. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

In some embodiments, retrieval augmented generation (RAG) may be used to provide LLM with context regarding the entrepreneur. For example, a user profile may be automatically pulled in and provided as input to the LLM with a user query. In some embodiments, a data structure representing the entrepreneur’s roadmap may be provided as input to the LLM

In some aspects, the techniques described herein relate to a method for obtaining regulated crowd-sourced funds, the method including: receiving, using at least one processor, from a user, an input including roadmap task data related to a roadmap; inputting, using the at least one processor, the roadmap task data into a chatbot; and determining, using the at least one processor and the chatbot, an output, wherein the output includes one or more suggested actions, wherein the suggested actions are configured to move a user along the roadmap.

In some aspects, the techniques described herein relate to a method, wherein the user is an entrepreneur.

In some aspects, the techniques described herein relate to a method, wherein the roadmap includes an entrepreneur's roadmap.

In some aspects, the techniques described herein relate to a method, wherein: the entrepreneur's roadmap includes a plurality of roadmap tasks; and each of the plurality of roadmap tasks is assigned to a category chosen from the list consisting of create, grow, and exit.

In some aspects, the techniques described herein relate to a method, wherein, the chatbot includes an artificial-intelligence enabled chatbot.

In some aspects, the techniques described herein relate to a method, wherein the artificial-intelligence enabled chatbot includes a large language model (LLM), wherein the large language model (LLM) is configured to generate textual data as output in response to the input received from the user.

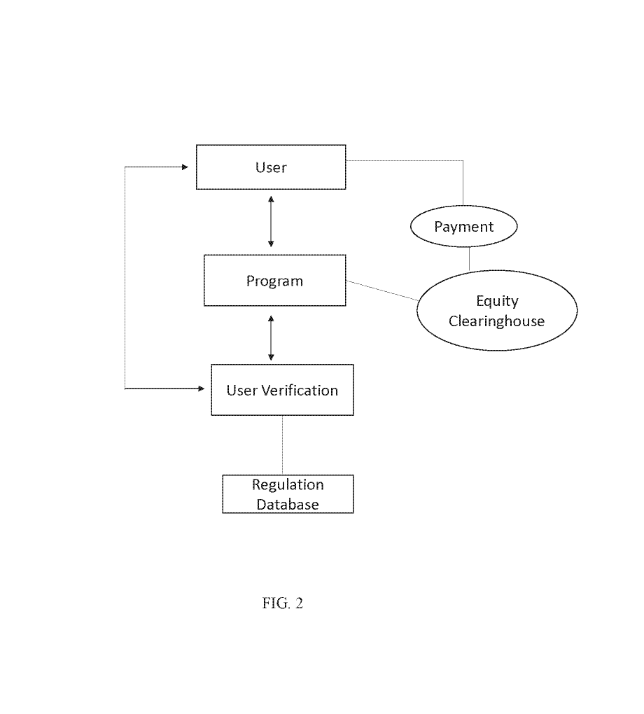

Referring to FIG. 2 an exemplary embodiment of a system for obtaining regulated crowd-sourced funds is shown. System may include, as non-limiting examples, a user, a program, user verification, a regulation database, a payment, and/or an entity clearing house. In some embodiments, chatbot and/or LLM as described above may be configured to query regulation database either to generate output or as a part of RAG.

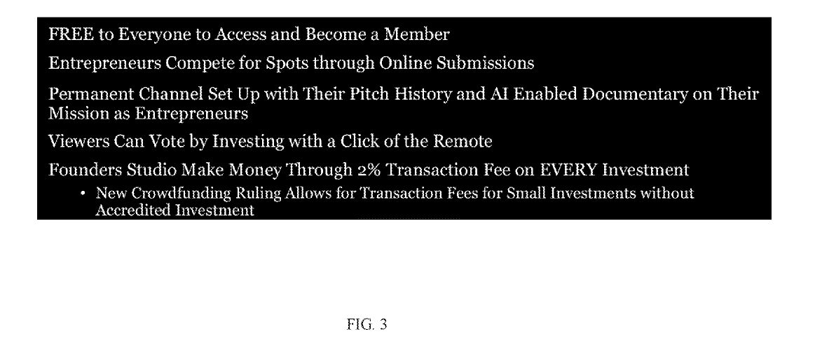

Referring to FIG. 3., it shows exemplary data related to a system for obtaining regulated crowd-sourced funds.

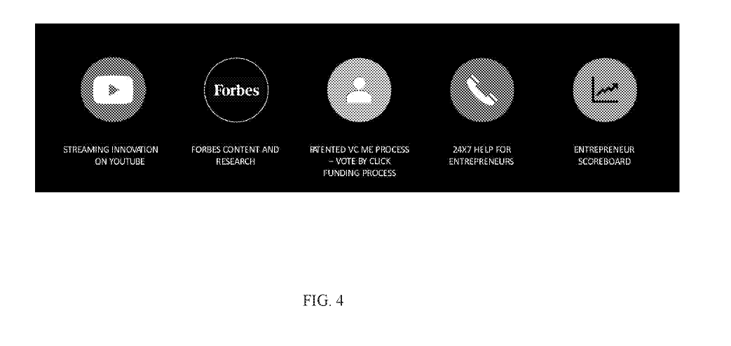

Referring to FIG. 4 it shows an exemplary user interface. User interface may include, as non-limiting examples, a link to YOUTUBE or other video sharing site, a like to a news site (e.g., FORBES), a like to a vote by click funding process, a like to a help line or help chat, and/or a link to an entrepreneur scoreboard.

Referring now to FIG. 5 , an exemplary embodiment of a machine-learning module 500 is shown. Machine-learning module 500 may be configured to perform one or more machine learning processes as described throughout this disclosure. Machine-learning module 500 may perform determinations, classification, and/or analysis steps, methods, processes, or the like as described in this disclosure using machine learning processes. A “machine learning process,” as used in this disclosure, is a process that automatedly uses training data 505 to generate one or more machine-learning models 510.

With continued reference to FIG. 5, for the purposes of this disclosure, “training data” is data that contains correlations that a machine-learning process may use to model relationships between two or more types of data. For example, training data 505 may include one or more training examples. Multiple data entries in training data 505 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. In some embodiments, training data 505 may include input training data correlated to output training data. Input training data may include, as a non-limiting example input queries, as described further throughout this disclosure. Output training data may include, as a non-limiting example output responses, as described further throughout this disclosure. Elements in training data 505 may be linked to descriptors of categories by tags, tokens, or other data elements; for instance, and without limitation, training data 505 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

With continued reference to FIG. 5, in some embodiments, training data 505 may be divided into different formats, categories, and/or groups. For example, in some embodiments, training data 505 may be divided into one or more cohorts, categorizations, time periods, data sources, and the like. In some embodiments, training data 505 may be assigned to categories using a classifier; as a non-limiting example, a training data classifier. Training data classifier may include a machine-learning module as described elsewhere with respect to FIG. 5. For example, in some embodiments, training data 505 may be input into training data classifier and training data classifier may output a classification. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 500 may generate a classifier using a classification algorithm, defined as a processes whereby a computing device and/or any module and/or component operating thereon derives a classifier from training data 505. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher’s linear discriminant, quadratic classifiers, decision trees, boosted trees, random forest classifiers, learning vector quantization, and/or neural network-based classifiers.

With continued reference to FIG. 5, training data 505 may be retrieved, in some embodiments, from a data structure 515. A data structure 515 may be remote to a computing device and communicative with a computing device by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure a computing device connect directly, dynamically, and non-hierarchically to as many other computing devices as possible. A “network topology” as used in this disclosure is an arrangement of elements of a communication network. data structure 515 may be implemented, without limitation, as a relational database, a key-value retrieval database such as a NOSQL database, or any other format or structure for use as a database that a person skilled in the art would recognize as suitable upon review of the entirety of this disclosure. data structure 515 may alternatively or additionally be implemented using a distributed data storage protocol and/or data structure, such as a distributed hash table or the like. data structure 515 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In an embodiment, data structure 515 may be a generic storage mechanism. A generic storage mechanism may be a storage system or method that is not specific to any particular type or format of data, that is, a storage solution that provides a flexible and adaptable way to store and retrieve data without being tied to a specific data format, schema, or domain. In some embodiments, training data 505 may be stored in data structure 515. In some embodiments, training data 505 may be retrieved from data structure 515.

With continued reference to FIG. 5, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

With continued reference to FIG. 5, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

With continued reference to FIG. 5, a “machine-learning model,” as used in this disclosure, is a data structure representing and/or instantiating a mathematical and/or algorithmic representation of a relationship between inputs and outputs as generated using any machine-learning process. For example, machine-learning process may include, without limitation, any machine-learning process described in this disclosure.

With continued reference to FIG. 5, machine-learning process may include an unsupervised machine-learning process 520. An unsupervised machine-learning process, as used herein, is a process that derives inferences in datasets without regard to labels; as a result, an unsupervised machine-learning process may be free to discover any structure, relationship, and/or correlation provided in the data. Unsupervised processes machine-learning process 520 may not require a response variable; unsupervised processes machine-learning process 520 may be used to find interesting patterns and/or inferences between variables, to determine a degree of correlation between two or more variables, or the like.

With continued reference to FIG. 5, machine-learning process may include a supervised machine-learning process 525. Supervised machine-learning process 525 may use training data 505 with both exemplary inputs and expected outputs and use that training data 505 to train a machine-learning model 510. For example, during a training process, machine learning process may evaluate an actual output generated by machine-learning model 510 and compare it to an expected output from training data 505. Based on the difference between the actual and expected outputs, one or more weights within machine-learning model 510 may be updated. For example, in some cases a scoring function may be used to train machine-learning model 510. Scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 505.

With continued reference to FIG. 5, machine-learning process may include a lazy-learning process 530. Lazy learning is a machine-learning approach in which the model delays generalization until a query is made. For example, this can be rather than learning a global model during training. Instead of building an abstract representation of the data up front, a lazy learner may store the training instances and wait until it needs to make a prediction. For example, when a new input arrives, the system may perform computation on the fly. Because no heavy training occurs in advance, lazy-learning algorithms may be fast to set up but can be computationally expensive at prediction time and often require storing large datasets in memory. An example may include k-nearest neighbors (k-NN), which classifies new points based on the labels of their closest neighbors in the stored data. Lazy learning may adapt naturally to new data because the “model” is effectively the dataset itself, but this also means it can be sensitive to noise and may not scale well with very large datasets.

With continued reference to FIG. 5, in some embodiments, machine-learning module 500 may receive external feedback 535. External feedback 535 may include, as a non-limiting example, feedback received from a user. In some embodiments, external feedback 535 may be received through a user interface (such as, for example, a graphical user interface (GUI).

With continued reference to FIG. 5, machine-learning module 500 may be configured to re-train machine-learning model 510. In some embodiments, re-training machine-learning model 510 may include re-training machine-learning model 510 as a function of external feedback 535. In some embodiments, external feedback 535 may serve as a source of labeled or partially labeled data that reflects how the model performs in real-world conditions. For example, if a user provides negative external feedback 535, then the set of data from training data 505 may be assigned a negative label. In some embodiments, external feedback 535 may include users correcting an output 540 of machine-learning model 510—such as flagging an incorrect prediction, choosing a preferred recommendation, or providing explicit labels. These interactions can be collected and added back into the training dataset. Over time, this additional data may help the model adapt to new patterns, correct systematic errors, and better align with user expectations. The re-training process may include cleaning and validating external feedback 535, merging it with existing datasets such as training data 505, and/or periodically running a new training cycle to update model parameters.

With continued reference to FIG. 5, machine-learning module 500 may be configured to validate machine-learning model 510. In some embodiments, machine-learning module 500 may validate machine-learning model 510 using validation data 545. Validation data 545 may be a subset of data used to train machine-learning model 505. For example, validation data 545 may include a subset of training data 505. In some embodiments, validation data 545 may include a percentage of training data 505. As non-limiting example, validation data 545 may include 1%,2%, 5%, 10%, 20%, 30%, and the like of training data 505. In some embodiments, machine-learning model 510 may not be exposed to validation data 545 during training. Validation data 545 may acts as a checkpoint that helps determine whether the model is generalizing well or simply memorizing training data 505. As the model learns, its performance on the validation set may be monitored to guide decisions such as choosing hyperparameters, selecting architectures, adjusting regularization strength, or determining when to stop training to avoid overfitting.

With continued reference to FIG. 5, machine-learning model 510 may be configured to receive one or more inputs 550 and generate, as a function of the one or more inputs 550, one or more outputs 540. Outputs 540 may be presented to users for example trough user interfaces and/or GUIs. In some embodiments, external feedback 535 may be received users as a function of output 540.

With continued reference to FIG. 5, one or more, processes, machine-learning processes, actions, steps, or the like as disclosed above may be performed using dedicated hardware 555. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware 555 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware 555 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware 555 to perform one or more operations described herein, such as evaluation of model and/or algorithm outputs, one-time or iterative updates to parameters, coefficients, weights, and/or biases, and/or any other operations such as vector and/or matrix operations as described in this disclosure.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

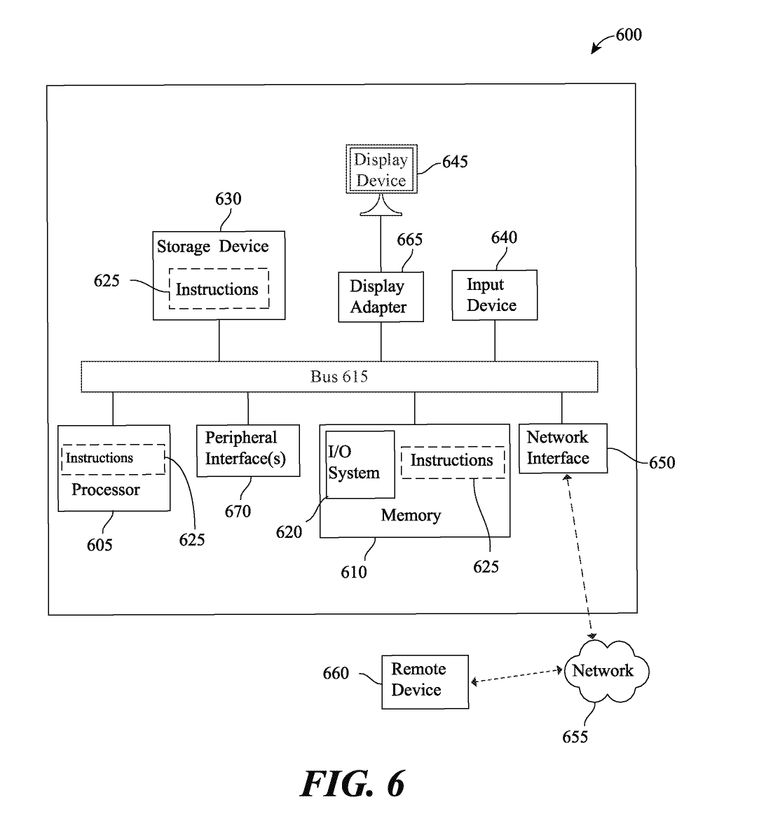

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 605 and a memory 610 that communicate with each other, and with other components, via a bus 615. Bus 615 may include any of several types of bus structures including, but not limited to, a memory bus, a memory controller, a peripheral bus, a local bus, and any combinations thereof, using any of a variety of bus architectures.

Processor 605 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 605 may be organized according to Von Neumann and/or Harvard architecture as a non-limiting example. Processor 605 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo’s algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 610 may include various components (e.g., machine-readable media) including, but not limited to, a random-access memory component, a read only component, and any combinations thereof. In one example, a basic input/output system 620 (BIOS), including basic routines that help to transfer information between elements within computer system 600, such as during start-up, may be stored in memory 610. Memory 610 may also include (e.g., stored on one or more machine-readable media) instructions (e.g., software) 625 embodying any one or more of the aspects and/or methodologies of the present disclosure. In another example, memory 610 may further include any number of program modules including, but not limited to, an operating system, one or more application programs, other program modules, program data, and any combinations thereof. Memory 610 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 600 may also include a storage device 630. Examples of a storage device (e.g., storage device 630) include, but are not limited to, a hard disk drive, a magnetic disk drive, an optical disc drive in combination with an optical medium, a solid-state memory device, and any combinations thereof. Storage device 630 may be connected to bus 615 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 630 (or one or more components thereof) may be removably interfaced with computer system 600 (e.g., via an external port connector (not shown)). Particularly, storage device 630 and an associated machine-readable medium may provide nonvolatile and/or volatile storage of machine-readable instructions, data structures, program modules, and/or other data for computer system 600. In some embodiments, storage device 630 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 625) may reside, completely or partially, within machine-readable medium . In another example, software may reside, completely or partially, within processor 605.

Computer system 600 may also include an input device 640. In one example, a user of computer system 600 may enter commands and/or other information into computer system 600 via input device 640. Examples of an input device 640 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 640 may be interfaced to bus 615 via any of a variety of interfaces (not shown) including, but not limited to, a serial interface, a parallel interface, a game port, a USB interface, a FIREWIRE interface, a direct interface to bus 615, and any combinations thereof. Input device 640 may include a touch screen interface that may be a part of or separate from display 645, discussed further below. Input device 640 may be utilized as a user selection device for selecting one or more graphical representations in a graphical interface as described above.

A user may also input commands and/or other information to computer system 600 via storage device 630 (e.g., a removable disk drive, a flash drive, etc.) and/or network interface device 650. A network interface device, such as network interface device 650, may be utilized for connecting computer system 600 to one or more of a variety of networks, such as network 655, and one or more remote devices 660 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data neitwork associated with a telephone/voice provider (e.g., a mobile communications provider data and/or voice network), a direct connection between two computing devices, and any combinations thereof. A network, such as network 655, may employ a wired and/or a wireless mode of communication. In general, any network topology may be used. Information (e.g., data, software, etc.) may be communicated to and/or from computer system 600 via network interface device 650.

Computer system 600 may further include a video display adapter 665 for communicating a displayable image to a display device, such as display 645. Examples of a display device include, but are not limited to, a liquid crystal display (LCD), a cathode ray tube (CRT), a plasma display, a light emitting diode (LED) display, and any combinations thereof. Display adapter 665 and display 645 may be utilized in combination with processor 605 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 615 via a peripheral interface 670. Examples of a peripheral interface include, but are not limited to, a serial port, a USB connection, a FIREWIRE connection, a parallel connection, and any combinations thereof.

Further referring to FIG. 6, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 6, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 6, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 600, processor 605, and memory 610 may be virtualized; that is, a virtual machine and/or container may interact directly with such computing system 600, processor 605, and/or memory 610, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 605 comprises a plurality of processors and/or processor cores, virtualization may, in some cases, simulate or emulate a single (virtual) processor whose functions are allocated to one or more of the plurality of processors and/or processor cores. In this case, while processor 605 may be said to be virtualized, the processor 605, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for obtaining regulated crowd-sourced funds, the system comprising:
at least one processor, and
a memory communicatively connected to the at least one processor, wherein the memory contains instructions configuring the at least one processor to:
receive, from a user, an input comprising roadmap task data related to a roadmap;
input the roadmap task data into a chatbot; and
determine, using the chatbot, an output, wherein the output comprises one or more suggested actions, wherein the suggested actions are configured to move a user along the roadmap.

2. The system of claim 1, wherein the user is an entrepreneur.

3. The system of claim 2, wherein the roadmap comprises an entrepreneur’s roadmap.

4. The system of claim 3, wherein:
the entrepreneur’s roadmap comprises a plurality of roadmap tasks; and
each of the plurality of roadmap tasks is assigned to a category chosen from a list consisting of create, grow, and exit.

5. The system of claim 1, wherein, the chatbot comprises an artificial-intelligence enabled chatbot.

6. The system of claim 5, wherein the artificial-intelligence enabled chatbot comprises a large language model (LLM), wherein the large language model (LLM) is configured to generate textual data as output in response to the input received from the user.

7. A method for obtaining regulated crowd-sourced funds, the method comprising:
receiving, using at least one processor, from a user, an input comprising roadmap task data related to a roadmap;
inputting, using the at least one processor, the roadmap task data into a chatbot; and
determining, using the at least one processor and the chatbot, an output, wherein the output comprises one or more suggested actions, wherein the suggested actions are configured to move a user along the roadmap.

8. The method of claim 7, wherein the user is an entrepreneur.

9. The method of claim 8, wherein the roadmap comprises an entrepreneur’s roadmap.

10. The method of claim 9, wherein:
the entrepreneur’s roadmap comprises a plurality of roadmap tasks; and
each of the plurality of roadmap tasks is assigned to a category chosen from a list consisting of create, grow, and exit.

11. The method of claim 7, wherein, the chatbot comprises an artificial-intelligence enabled chatbot.

12. The method of claim 11, wherein the artificial-intelligence enabled chatbot comprises a large language model (LLM), wherein the large language model (LLM) is configured to generate textual data as output in response to the input received from the user.
